(19) United States
(12) Patent Application Publication
(10) Pub. No.: US 2006/0049117 A1
(43) Pub. Date: Mar. 9, 2006

(54) Catalyst module and liquid waste treating apparatus equipped with catalyst module

(76) Inventors: Norio Yamaguchi, Osaka (JP); Akinori Kawachi, Uji-shi, Kyoto (JP)

Correspondence Address: DENNISON, SCHULTZ, DOUGHERTY & MACDONALD, 1727 KING STREET, SUITE 105, ALEXANDRIA, VA, 22314, US

(21) Appl. No.: 10/542,775

(22) PCT Filed: Jan. 29, 2004
(86) PCT No.: PCT/JP04/00874

§ 371 Date: Aug. 5, 2005

(30) Foreign Application Priority Data
Jan. 31, 2003 (JP) 2003-025216
Jan. 31, 2003 (JP) 2003-025215

(51) Int. Cl. C02F 1/68

(52) U.S. Cl. 210/749

(57) ABSTRACT

There is provided a catalyst module having a waste liquid inlet passage for the inflow of a waste liquid, whose partition wall is formed of fibrous activated carbon, in which: the fibrous activated carbon is impregnated with or contains a catalyst; and a waste liquid in the waste liquid inlet passage passes through the partition wall and is discharged out of the waste liquid inlet passage. Further, there is provided a catalyst module, in which a plurality of waste liquid inlet passages is arranged in the form of a bundle. In the catalyst module are also provided partition walls formed of a fibrous activated carbon layer prepared by laminating a plurality of the fibrous activated carbon in the form of sheets.

### TECHNICAL FIELD

The present invention relates to a treatment technique for decomposing components in various waste liquids, such as a hydrogen peroxide-containing waste liquid, by using fibrous activated carbon, and more specifically to a technique for obtaining excellent treatment efficiency by using fibrous activated carbon formed into a sheet.

### BACKGROUND ART

Examples of treatment methods for various waste liquids such as a hydrogen peroxide-containing waste liquid discharged from a semiconductor or liquid crystal manufacturing process conventionally include: a method involving enzyme degradation; a method involving chemical neutralization; and a method involving catalyst decomposition.

The method involving enzyme degradation generally requires a predetermined reaction time and thus requires a large reaction tank. Further, the reaction tank must be provided with a stirring device, and thus the reactor itself may considerably increase in size depending on water volume.

The method involving chemical neutralization has problems of requiring the use of acid or alkali chemicals for neutralization, and the formation of neutralized byproducts. In waste liquid treatment, the discharge of those chemicals and byproducts out of the treatment system must be minimized. As a result, additional treatment facilities and the like are required.

The method involving catalyst decomposition has no problems associated with chemicals, byproducts, and the like. Further, the reaction is relatively fast, and thus the method is appropriate for a continuous waste liquid treatment process. However, in a case where a catalyst is in the form of particles, the small specific surface areas of the catalyst inhibit improvement in treatment efficiency, and thus the reactor itself tends to increase in size. In a case where a catalyst is in the form of particles and a gas generates through a decomposition reaction of waste liquid components, a reactor must have a passage structure for directing the flow of the waste liquid upward in order to discharge the gas out of the system. This case has problems in that the catalyst physically abrades, and that the abraded catalyst is liable to be scattered upward as fine powder.

Meanwhile, fibrous activated carbon has been recently developed. The fibrous activated carbon is molded into a sheet and then rolled spirally for use as a cartridge-type catalyst module (JP 07-144189 A)

The case of using a catalyst layer prepared by forming activated carbon into a sheet and spirally rolling the sheet form of the activated carbon can suppress the generation of fine power, but has problems of a large passage resistance to the waste liquid and difficulties in high-speed treatment. In a catalyst layer containing entangled fibrous activated carbon, the waste liquid oftentimes is hardly brought into uniform contact with the catalyst layer for a reaction, and the catalyst layer is liable to degrade at the part of the waste liquid inlet. Further, fine powder in the waste liquid is liable to clog the waste liquid inlet. In a case where a reaction proceeds at a part of the catalyst layer and a gas is generated through a reaction in the catalyst layer, the gas is not discharged smoothly. As a result, efficient waste liquid treatment cannot be assured.

Therefore, the present invention provides: a catalyst module employing fibrous activated carbon allowing for efficient waste liquid treatment; and a waste liquid treatment apparatus provided with the catalyst module.

### DISCLOSURE OF THE INVENTION

The inventors of the present invention have conducted studies on a configuration of a catalyst module able to realize efficient waste liquid treatment. The inventors of the present invention have found that a catalyst module having a configuration in which a plurality of waste liquid inlet passages are arranged in a form of a bundle, or in which partition walls of waste liquid inlet passages are formed of layers of fibrous activated carbon, enables the formation of a uniform catalytic reaction field in the catalyst module and allows for efficient waste liquid treatment. Thus, the inventors have completed the present invention constructed as described below.

(1) A catalyst module having a waste liquid inlet passage for the inflow of a waste liquid, whose partition walls are formed of fibrous activated carbon, in which: the fibrous activated carbon is impregnated with or contains a catalyst; and the waste liquid in the waste liquid inlet passage passes through the partition walls and is discharged out of the waste liquid inlet passage.

(2) A catalyst module according to the above item (1), in which a plurality of the waste liquid inlet passages are arranged in the form of a bundle.

(3) A catalyst module according to the above item (2), in which the plurality of waste liquid inlet passages are each formed between a first partition wall formed to have a wavy section and a second partition wall arranged to follow one side of the first partition wall.

(4) A catalyst module according to the above item (3), in which the first partition wall and the second partition wall are arranged concentrically or spirally.

(5) A catalyst module according to any one of the above items (1) to (4), in which the fibrous activated carbon is impregnated with or contains silver as a catalyst.

(6) A catalyst module according to any one of the above items (2) to (4), including a surface layer surrounding an outer periphery of the plurality of waste liquid inlet passages arranged in the form of a bundle, in which the surface layer is formed of a material inhibiting the passage of a liquid.

(7) A catalyst module according to the above item (6), in which the surface layer is formed of a material inhibiting the passage of a liquid but allowing the passage of a gas alone.

(8) A catalyst module according to the above item (1), in which the partition wall is formed of a fibrous activated carbon layer prepared by laminating a plurality of layers of fibrous activated carbon in a form of a sheet.

(9) A catalyst module according to the above item (8), in which the partition wall has a projecting part projecting into the waste liquid inlet passage.

(10) A catalyst module according to the above item (8), in which the fibrous activated carbon in a form of a sheet is formed into a bag having an open lower end.

(11) A catalyst module according to the above item (8), in which a mesh member is arranged between the layers of fibrous activated carbon in the form of a sheet.

(12) A catalyst module according to the above item (8), in which: an inlet port of the waste liquid is provided at a lower end of the waste liquid inlet passage; and an end of the waste liquid inlet passage opposite to the inlet port is closed so as to inhibit the passage of a liquid.

(13) A catalyst module according to any one of the above items (8) to (12), in which the fibrous activated carbon is impregnated with or contains silver as a catalyst.

(14) A waste liquid treatment apparatus including a waste liquid treatment tank capable of holding one or a plurality of the catalyst modules according to any one of the above items (1) to (4), in which: the waste liquid storage tank temporarily stores a treated liquid discharged from the catalyst module; and the stored treated liquid is discharged out of the waste liquid treatment tank at a predetermined liquid level.

(15) A waste liquid treatment apparatus including a waste liquid treatment tank capable of holding one or a plurality of the catalyst modules according to the above item (5), in which: the waste liquid storage tank temporarily stores a treated liquid discharged from the catalyst module; and the stored treated liquid is discharged out of the waste liquid treatment tank at a predetermined liquid level.

(16) A waste liquid treatment apparatus including a waste liquid treatment tank capable of holding one or a plurality of the catalyst modules according to any one of the above items (8) to (12), in which: the waste liquid storage tank temporarily stores a treated liquid discharged from the catalyst module; and the stored treated liquid is discharged out of the waste liquid treatment tank at a predetermined liquid level.

(17) A waste liquid treatment apparatus including a waste liquid treatment tank capable of holding one or a plurality of catalyst modules according to the above item (13), in which: the waste liquid storage tank temporarily stores a treated liquid discharged from the catalyst module; and the stored treated liquid is discharged out of the waste liquid treatment tank at a predetermined liquid level.

(18) A waste liquid treatment apparatus according to the above item (15), in which a plurality of the catalyst modules are held in the waste liquid treatment tank in parallel with the inflow direction of the waste liquid.

### BRIEF DESCRIPTION OF THE DRAWINGS

FIG. 1 is a perspective view of a catalyst module.

FIG. 2 is an enlarged sectional view of the catalyst module.

FIG. 3 is a sectional view of fibrous activated carbon formed by attaching together a first partition wall and a second partition wall.

FIG. 4 is a perspective view of a catalyst module having a configuration different from the catalyst module of FIG. 1.

FIG. 5 is a perspective view of a catalyst module having another configuration.

FIG. 6 is a perspective view of a catalyst module having still another configuration.

FIG. 7 is a perspective view of a catalyst module having yet another configuration.

FIG. 8 is an explanatory drawing of a method of producing a catalyst module.

FIG. 9 is a perspective view showing an example of a catalyst module provided with a projecting part in a partition wall.

FIG. 10 is a perspective view showing another example of a catalyst module provided with a projecting part in a partition wall.

FIG. 11 is a perspective view showing still another example of a catalyst module provided with a projecting part in a partition wall.

FIG. 12 is an explanatory drawing of a method of producing the catalyst module shown in FIG. 9.

FIG. 13 is an explanatory drawing of a method of producing the catalyst module shown in FIG. 10.

FIG. 14 is an explanatory drawing of a method of producing the catalyst module shown in FIG. 11.

FIG. 15 is an explanatory drawing of another method of producing a catalyst module.

FIG. 16 is a perspective view of fibrous activated carbon formed into a sheet and a bag.

FIG. 17 is a sectional view of a waste liquid treatment apparatus.

FIG. 18 is a perspective view showing the inside of a waste liquid treatment apparatus.

FIG. 19 is a flow diagram of a semiconductor substrate manufacturing plant.

### BEST MODE FOR CARRYING OUT THE INVENTION

Hereinafter, the best mode for carrying out the present invention will be described in detail by referring to the figures.

(Catalyst Module)

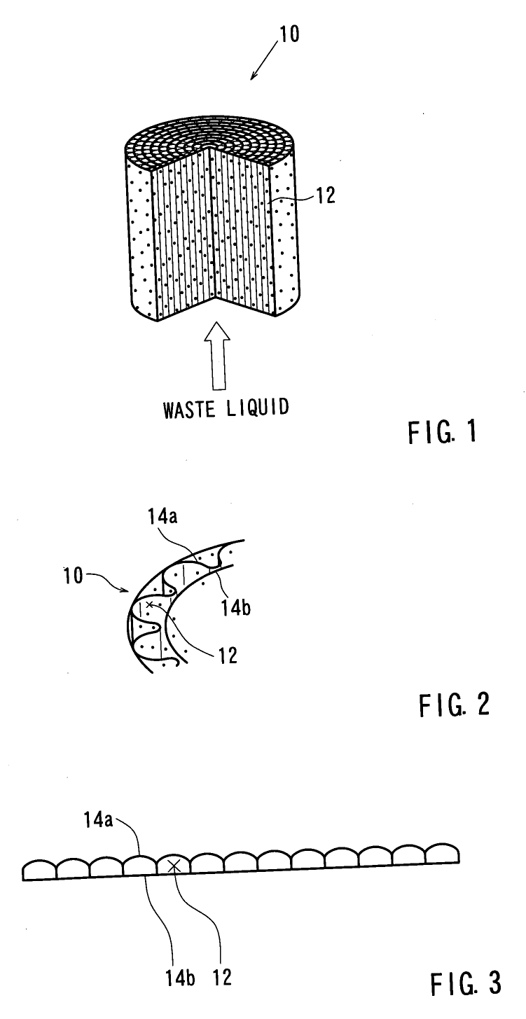

FIG. 1 is a perspective view of a catalyst module 10. As shown in FIG. 1, the catalyst module 10 is provided with a plurality of waste liquid inlet passages 12 in the form of a bundle for the inflow of a waste liquid. That is, in the catalyst module 10, the plurality of waste liquid inlet passages 12 are assembled such that the passage lines are oriented in the same direction. The waste liquid inlet passages 12 have partition walls of fibrous activated carbon. The partition walls divide the waste liquid inlet passages 12 from one another. Note that, various shapes maybe employed as the sectional shape of the waste liquid inlet passages 12 without any particular limitation.

FIG. 2 is an enlarged sectional view of the catalyst module 10. As shown in FIG. 2, the waste liquid inlet passage 12 in the catalyst module 10 is formed between a first partition wall 14a, formed to have an undulating (wavy) type of uneven section, and a second partition wall 14b arranged to correspond to one side of the first partition wall 14a. The first partition wall 14a and the second partition wall 14b are each formed of fibrous activated carbon in the form of a thin sheet. The first partition wall 14a and the second partition wall 14b are arranged concentrically and alternatively as a whole.

FIG. 3 is a sectional view of fibrous activated carbon formed by attaching together the first partition wall 14a and the second partition wall 14b. As shown in FIG. 3, the first partition wall 14a and the second partition wall 14b are attached together and are rolled spirally, to thereby obtain a catalyst module 10 having a plurality of waste liquid inlet passages 12 arranged in the form of a bundle. That is, the first partition wall 14a and the second partition wall 14b maybe arranged concentrically and alternatively, or they may be attached together and then spirally rolled. The first partition wall 14a and the second partition wall 14b may be attached to each other via an adhesive, or they may be fused together via a synthetic resin or the like, for example.

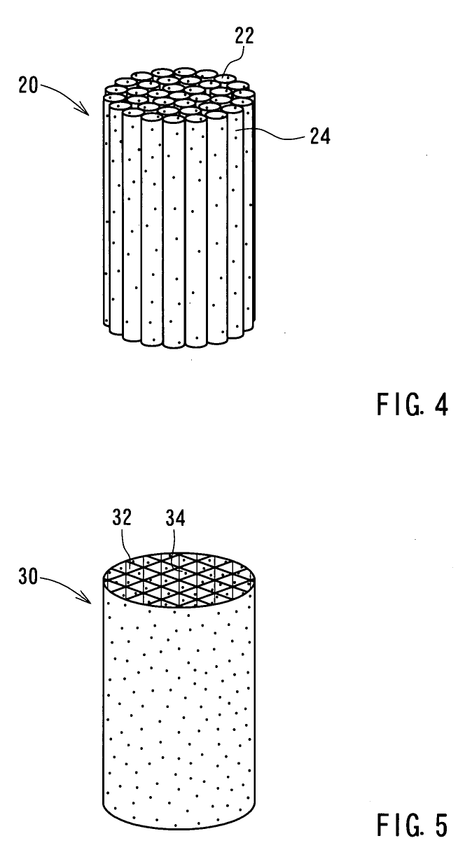

FIG. 4 is a perspective view of a catalyst module 20 having a configuration different from that of the catalyst module 10 of FIG. 1. As shown in FIG. 4, waste liquid inlet passages 22 in the catalyst module 20 are formed of cylindrical pipes 24 of fibrous activated carbon. That is, the catalyst module 20 is formed such that a plurality of pipes 24 is bundled so as to be in contact with each other at respective side surfaces. The pipes 24 serve as partition walls for forming the waste liquid inlet passages 22. In this case, the space between the adjoining pipes 24 also serves as waste liquid inlet passages for the inflow of waste liquid.

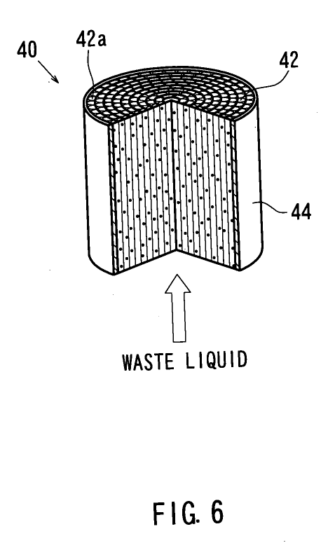

FIG. 5 is a perspective view of a catalyst module 30 having another configuration. As shown in FIG. 5, waste liquid inlet passages 32 in the catalyst module 30 are provided in a honeycomb shape formed by dividing the interior of a cylindrical fibrous activated carbon by numerous partition walls 34. In this case, the catalyst module 30 maybe constructed by combining fibrous activated carbon molded into a plate in advance, or the catalyst module 30 may be constructed by integrally molding the fibrous activated carbon.

FIG. 6 is a perspective view of a catalyst module 40 having still another configuration. As shown in FIG. 6, the catalyst module 40 is provided with a surface layer 44 surrounding an outer periphery of a plurality of waste liquid inlet passages 42 arranged in the form of a bundle. That is, the surface layer 44 is arranged on an outer periphery of the outermost waste liquid inlet passages 42a. The surface layer 44 is formed of a material in a form of a thin sheet, inhibiting the passage of a liquid. Thus, the scattering of untreated waste liquid from out of the catalyst module 40 can be prevented. Contact efficiency between the untreated waste liquid and a catalyst in the fibrous activated carbon can be improved.

Further, the surface layer 44 maybe formed of a material having selective permeability, inhibiting the passage of a liquid but allowing the passage of a gas. The surface layer 44, formed of a material having selective permeability, allows a gas generated through a decomposition reaction or the like in the catalyst module 40 to separate from the waste liquid, and also allows a rapid discharge of the gas out of the system.

The surface layer 44 may be formed of a known material having a selective permeability or a selective barrier property. For example, the surface layer 44, inhibiting the passage of a liquid and a gas, maybe formed through a general resin coating. The surface layer 44, inhibiting the passage of a liquid but allowing the passage of a gas, may be formed through a coating or covering with a commercially available material having a selective permeability.

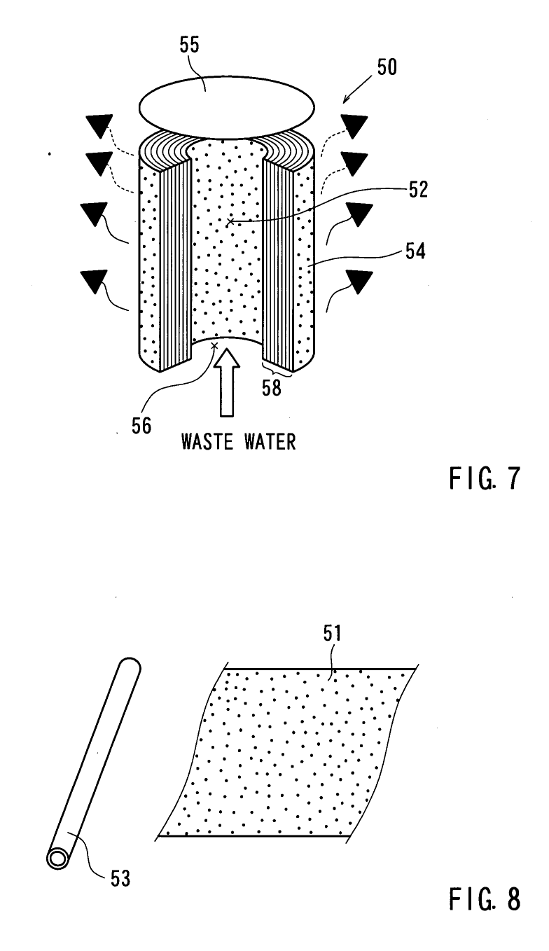

FIG. 7 is a perspective view of a catalyst module 50 having yet another configuration. As shown in FIG. 7, the catalyst module 50 is provided with a waste liquid inlet passage 52 formed by a partition wall 54 of fibrous activated carbon. First, an untreated waste liquid supplied to the catalyst module 50 flows into the waste liquid inlet passage 52 formed inside of the catalyst module 50. Then, the untreated waste liquid passes through the partition wall 54 of the fibrous activated carbon and is discharged out of the catalyst module 50. The separation wall 54 is formed of a fibrous activated carbon layer 58 through the lamination of a plurality of layers of fibrous activated carbon in a form of thin sheets. The waste liquid flows upward from an inlet port 56 provided at a lower end of the waste liquid inlet passage 52, passes through the fibrous activated carbon layer 58, and is discharged out of the catalyst module 50. The catalyst module 50 may have various shapes, but preferably has a cylindrical shape.

The waste liquid inlet passage 52 for inflow of the waste liquid may be formed at a height lower than the upper end of the catalyst module 50, but the waste liquid inlet passage 52 is preferably formed at the height of the catalyst module 50. A cylindrical member allowing the passage of a liquid may be provided as a core member inside of the waste liquid inlet passage 52. The core member may also serve as a structure-bearing member for the catalyst module 50. The core member may be formed of a cylindrical member having a wall portion in the form of mesh, or a cylindrical member having a porous wall portion of resin, ceramics, or metal, for example.

As shown in the catalyst module 50 of FIG. 7,regarding the upper and lower ends of the waste liquid inlet passage 52, the end opposite to the inlet port 56, which is provided at a lower end of the waste liquid inlet passage 52, is preferably closed to inhibit the passage of a liquid (i.e., the upper end is closed). More preferably, the entire upper end of the catalyst module 50, including the upper end of the waste liquid inlet passage 52, is closed. The closing method may employ a method of bonding a closing member 55 on the upper part of the catalyst module 50, for sealing. The closing member 55 is preferably formed of a material having a selective permeability, inhibiting the passage of a liquid but allowing the passage of a gas alone. The catalyst module 50 is provided with the closing member 55. Thereby the waste liquid that flows into the waste liquid inlet passage 56 passes through the fibrous activated carbon layer 58 and is forcibly discharged out of the catalyst module 50. In this way, the efficiency of a catalytic reaction for the treatment of the waste liquid can be improved.

FIG. 8 is an explanatory drawing of a method of producing the catalyst module 50. As shown in FIG. 8, using fibrous activated carbon 51 formed into a sheet can easily produce the catalyst module 50. That is, rolling the fibrous activated carbon 51 (formed into a sheet) several times around a cylindrical core member 53 can easily produce the catalyst module 50. Note that, a member allowing passage of a liquid, such as a mesh member of a thermoplastic synthetic resin, forms the core member 53. Such a structure provides a good shape retention property for the catalyst module 50 and facilitates the retention of strength. The sheet form of the fibrous activated carbon 51 may be obtained through: a method involving the mixing of fibrous activated carbon with another binder fiber such as a polyethylene fiber or a polypropylene fiber and the formation of the mixture into a sheet through a paper making method; and a method involving uniform mixing of fibrous activated carbon containing metals with a polyester composite fiber of a core-in-sheath structure and the formation of the mixture into a sheet through a dry process.

The catalyst module 50, which is formed into a cylindrical shape, may have a projecting part projecting from an inner wall portion of the partition wall 54 into the waste liquid inlet passage 52. In a case where such a projecting part is formed, the passage of a waste liquid out of the catalyst module 50 is accelerated through the projecting part.

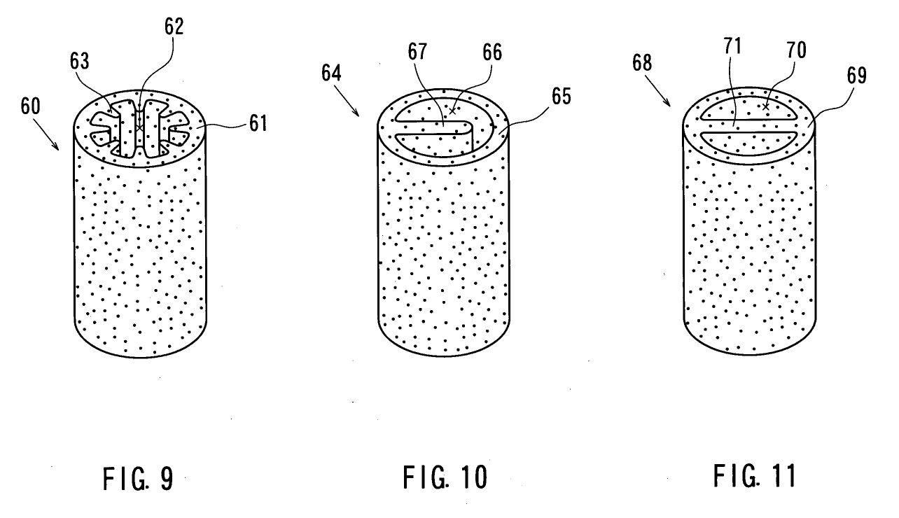

FIGS. 9 to 11 are each a perspective view showing an example of a catalyst module provided with a projecting part in a partition wall.

As shown in FIG. 9, a catalyst module 60 is provided with: a partition wall 61 formed of a fibrous activated carbon layer; and a projecting part 63 projecting from an inner wall part of the partition wall 61 into a waste liquid inlet passage 62. As shown in FIG. 9, the projecting part 63 may be configured as ribs that project at regular intervals along an inner periphery of the inner wall part of the partition wall 61 and that extend along the longitudinal direction of the catalyst module 60.

As shown in FIG. 10, a catalyst module 64 is provided with: a partition wall 65 formed of a fibrous activated carbon layer; and a projecting part 67 projecting from an inner wall part of the partition wall 65 into a waste liquid inlet passage 66. As shown in FIG. 10, the projecting part 67 may be provided in the form of a plate that extends inside of the waste liquid inlet passage 66 toward the opposing inner wall.

As shown in FIG. 11, a catalyst module 68 is provided with: a partition wall 69 formed of a fibrous activated carbon layer; and a projecting part 71 projecting from an inner wall part of the partition wall 69 into a waste liquid inlet passage 70. As shown in FIG. 11, the projecting part 71 may be provided in a form of a plate that extends throughout the waste liquid inlet passage 70.

Note that, the projecting parts 63, 67, and 71, are also formed so as to allow the passage of a waste liquid, similar to the other members. That is, the projecting parts 63, 67, and 71, are formed of fibrous activated carbon.

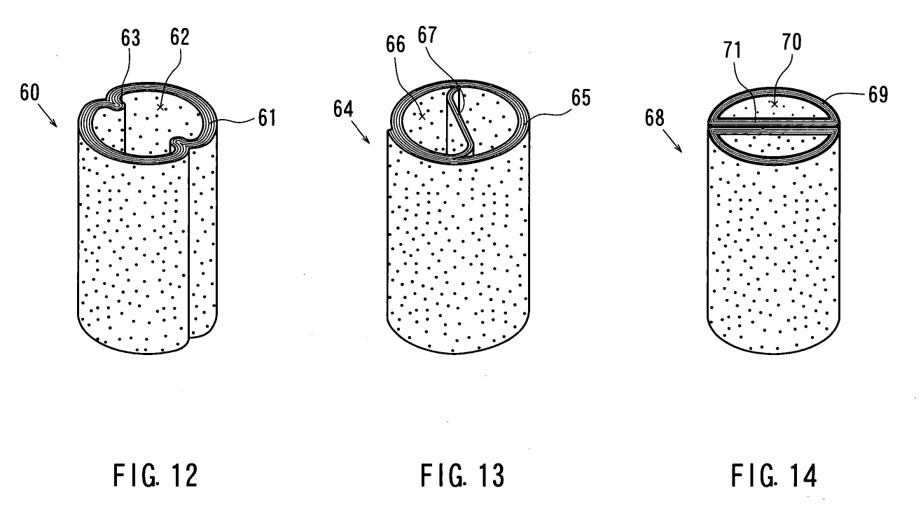

FIGS. 12 to 14 are each an explanatory drawing of a method of producing the catalyst module 60, 64, or 68, shown in each of FIGS. 9 to 11.

As shown in FIG. 12, the projecting part 63 may be formed on the partition wall 61 of the catalyst module 60 by bending inward the fibrous activated carbon layer forming the partition wall 61. As shown in FIG. 13, the projecting part 67 may be formed on the partition wall 65 of the catalyst module 64 by partly pulling out and bending an inner layer of the fibrous activated carbon layer forming the partition wall 65. As shown in FIG. 14, the projecting part 71 may be formed on the partition wall 69 of the catalyst module 68 by forming two cylindrical members of fibrous activated carbon layers, each having a semicircular cross-section, and bonding the two cylindrical members such that their respective flat surfaces face each other. The bonded flat surfaces serve as the projecting part 71.

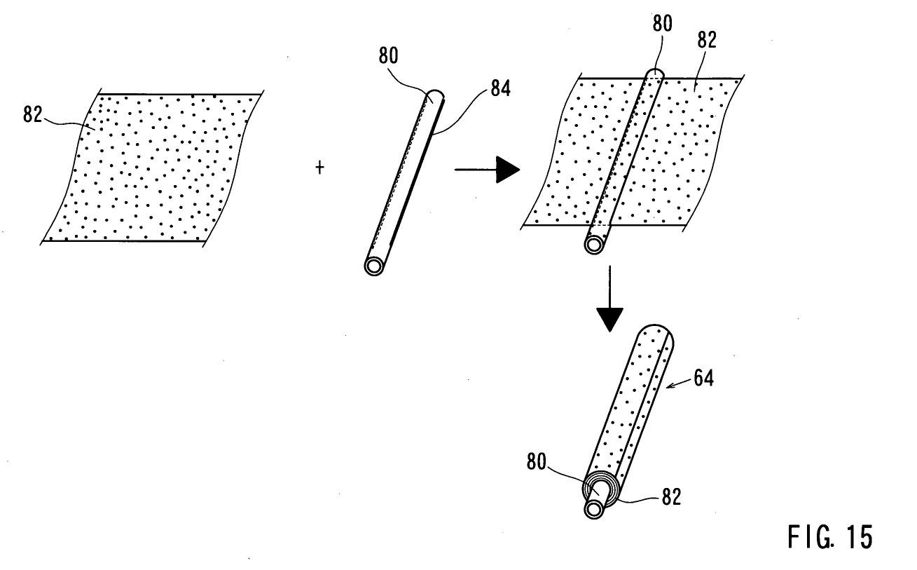

FIG. 15 is an explanatory drawing of another method of producing the catalyst module 64. Using a cylindrical core member 80 and fibrous activated carbon 82 in the form of a sheet can easily produce the catalyst module 64 shown in FIG. 13.

As shown in FIG. 15, in order to produce the catalyst module 64, the cylindrical core member 80 of a thermoplastic synthetic resin is prepared and a long and thin slit 84 is formed along a longitudinal direction of the core member 80. One end of the fibrous activated carbon 82 in the form of a sheet is inserted into the slit 84 and the core member 80 is rotated in one direction. Thus, the fibrous activated carbon 82 in the form of a sheet is rolled around the periphery of the core member 80 to thereby produce the catalyst module 64. In a case where the slit 84 is formed such that at least one end of the upper and lower ends thereof is open, an unnecessary core member 80 can be pulled upward or downward out of the produced catalyst module 64. In a case where the core member 80 is formed of a member (e.g., a mesh member) allowing the passage of a liquid, the core member 80 may remain as it is inside of the catalyst module 64.

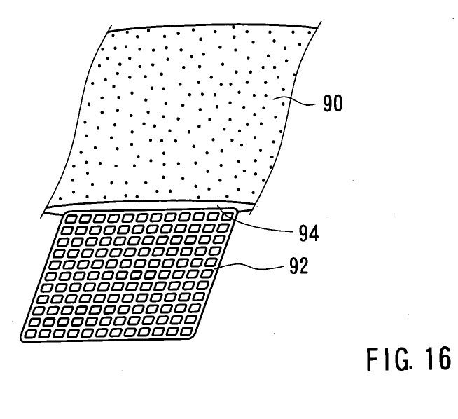

FIG. 16 is a perspective view of fibrous activated carbon 90 formed into a sheet and a bag. Fibrous activated carbon formed into a single sheet may be used as the fibrous activated carbon in the form of a sheet. However, as shown in FIG. 16, fibrous activated carbon formed into a bag having an open lower end may also be used as the fibrous activated carbon in the form of sheet. In a case where the fibrous activated carbon 90 in the form of bag is used, a mesh member 92, obtained by forming a thermoplastic synthetic resin into a mesh, may be inserted into the fibrous activated carbon 90 through a lower opening 94. The mesh member 92 is inserted to thereby maintain a predetermined interlayer distance of the fibrous activated carbon 90. In this way, the passage property of a waste liquid can be enhanced inside of the layers of fibrous activated carbon 90. As a result, use of such fibrous activated carbon 90 in the form of bag can increase the efficiency of a catalytic reaction for the treatment of the waste liquid without increasing the passage resistance of the waste liquid.

In this embodiment, examples of fibrous activated carbon for forming a partition wall of a catalyst module include: fibrous activated carbon in a form of a sheet prepared by mixing fibrous activated carbon with another binder fiber, such as a polyethylene fiber or a polypropylene fiber, and forming the mixture into a sheet through a paper making method; and fibrous activated carbon in a form of a sheet prepared by mixing fibrous activated carbon containing a catalyst for waste liquid treatment, such as silver, through the incorporation or the like with a polyester composite fiber of a core-in-sheath structure, and forming the mixture into a sheet through a dry process.

For formation of cylindrical fibrous activated carbon, fibrous activated carbon is dispersed in water by using several % of an organic polymer as a binder, such as polyethyleneimine, polyacrylic acid, polyacrylamide, a polyethylene fiber, or a polypropylene fiber, to thereby prepare a slurry. Then, the slurry is filtered under reduced pressure by using a cylindrical filter having a nonwoven fabric set to thereby form cylindrical fibrous activated carbon.

Pitch-based fibrous activated carbon, acrylic fibrous activated carbon, phenol-based fibrous activated carbon, cellulose-based fibrous activated carbon, or the like may be used as fibrous activated carbon for forming a catalyst module. However, a pitch-based fibrous activated carbon having an excellent oxidation resistance is preferable.

Examples of a catalyst added to or contained in a fibrous activated carbon include metals such as iron, cobalt, nickel, manganese, and silver. Of those, silver is particularly preferably used. Further examples of the catalyst may include compounds such as oxides or hydroxides of the metals. The amount of the metal used as a catalyst is preferably 0.01 to 5 wt % with respect to the amount of the fibrous activated carbon. If the metal content is less than 0.01 wt %, decomposition by the fibrous activated carbon itself is dominant over decomposition by the metal, and the fibrous activated carbon tends to be greatly consumed. If the metal content exceeds 5 wt %, the fibrous activated carbon hardly contains the metal as fine particles and the decomposition efficiency of hydrogen peroxide decreases on the contrary. Further, a metal content exceeding 5 wt % is expensive, especially for cobalt, nickel, silver, or the like.

Metals used as a catalyst may be contained in the fibrous activated carbon through any method. Silver may be contained in fibrous activated carbon, for example, through a method involving: immersion of fibrous activated carbon in an aqueous solution of silver nitrate; removal of the fibrous activated carbon from the solution; dehydration thereof; and heating thereof for the decomposition of silver nitrate. Further, silver may be contained in fibrous activated carbon through a method involving a silver mirror reaction or incorporation. Manganese, as a catalyst, may be contained in fibrous activated carbon through a method involving: blowing of ozone into an aqueous solution of manganese chloride for oxidation; and adsorption of produced manganese oxides and manganese ions on the fibrous activated carbon. Further, manganese may be contained as a catalyst in fibrous activated carbon through a method involving the mixing of fine particles of electrolytic manganese dioxide with a sheet of fibrous activated carbon.

Use of the catalyst module as described above can realize a waste liquid treatment appratus allowing for the formation of a uniform catalytic reaction field and an efficient waste liquid treatment.

(Waste Liquid Treatment Apparatus)

Hereinafter, specific structural examples of a waste liquid treatment apparatus employing the catalyst module will be described below by referring to figures.

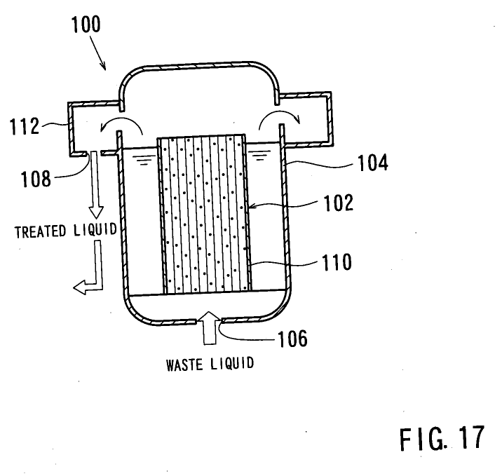

FIG. 17 is a sectional view of a waste liquid treatment apparatus 100. As shown in FIG. 17, the waste liquid treatment apparatus 100 is provided with: a catalyst module 102; and a waste liquid treatment tank 104 capable of holding one or plurality of catalyst modules 102. The waste liquid treatment tank 104 is provided with: a supply port 106 for supplying a waste liquid; and a discharge port 108 for discharging the waste liquid passed through and treated in the catalyst module 102 toward a subsequent process.

The waste liquid treatment tank 104 is constructed for temporarily storing treated liquid discharged from the catalyst module 102, and for discharging the stored treated liquid from the discharge port 108 at a predetermined liquid level. In the waste liquid treatment apparatus 100, in the case where a surface layer 110 is provided on an outer periphery of the catalyst module 102, the treated waste liquid is discharged into the waste liquid treatment tank 104 from an upper surface of the catalyst module 102 alone. In contrast, in a case where no surface layer 110 is provided on an outer periphery of the catalyst module 102, the treated waste liquid is discharged into the waste liquid treatment tank 104 from the outer periphery of the catalyst module 102.

In the case where the catalyst module 102 is provided with the surface layer 110, a catalytic reaction in the catalyst module 102 maybe accelerated. In contrast, in the case where the catalyst module 102 is provided with no surface layer 110, an outer surface of the catalytic module 102 is exposed to the waste liquid stored in the waste liquid treatment tank 104. Thus, the catalytic reaction proceeds between the waste liquid in the waste liquid treatment tank 104 and the outer surface of the catalyst module 102.

The waste liquid treatment apparatus 100 preferably has a size capable of including almost the entire height of the catalyst module 102. The liquid level for discharging the stored waste liquid (treated liquid) preferably is substantially at the same height as the height of the catalyst module 102 in the waste liquid treatment tank 104. For discharge of the stored waste liquid at a predetermined liquid level, a circular tub 112 capable of temporarily receiving a waste liquid discharged from an upper end of the waste liquid treatment tank 104 is preferably provided, and the discharge port 108 is preferably provided at a bottom of the tub 112.

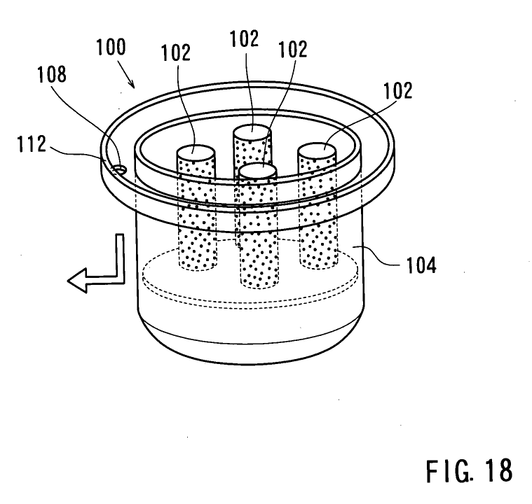

FIG. 18 is a perspective view showing the inside of a waste liquid treatment apparatus 100. Note that, the waste liquid treatment apparatus 100 shown in FIG. 18 holds a plurality of catalyst modules 102 inside of a waste liquid treatment tank 104. In a case where the waste liquid treatment tank 104 holds a plurality of catalyst modules 102 in parallel with the inflow direction of the waste liquid, the waste liquid treatment capacity per unit of time can be easily increased.

The waste liquid treatment apparatus 100 described above may be used for a treatment process of a waste liquid containing hydrogen peroxide, for example. To be specific, the waste liquid treatment apparatus 100 may be used for a treatment process of the waste liquid from the washing of substrates in a semiconductor substrate manufacturing plant, or a treatment process of the waste liquid in a liquid crystal manufacturing plant.

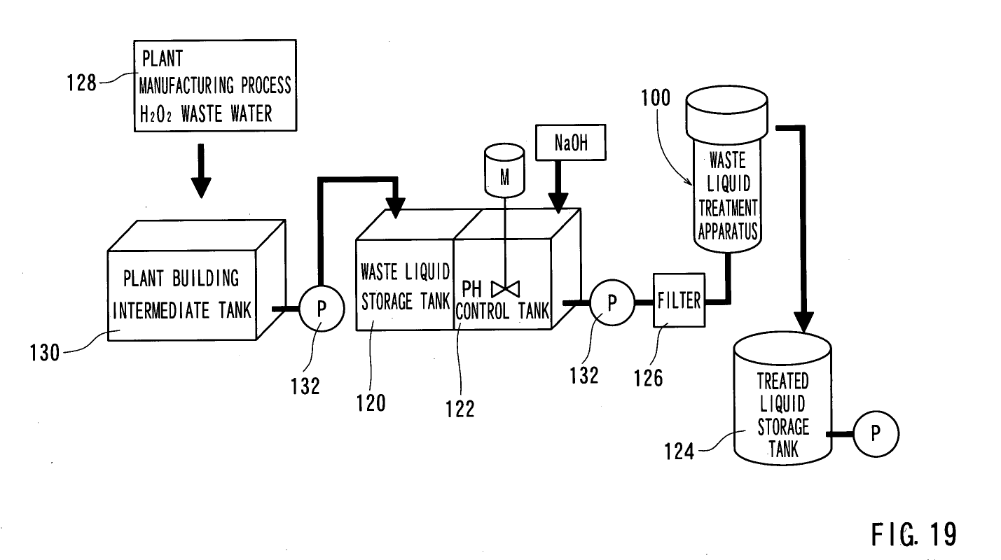

FIG. 19 is a flow diagram of a semiconductor substrate manufacturing plant, which is an application example of the waste liquid treatment apparatus according to the present invention. As shown in FIG. 19, a waste liquid storage tank 120, a pH control tank 122, a filter 126, and the like are provided upstream of a waste liquid treatment apparatus 100. A treated liquid storage tank 124, for the storing of the treated waste liquid, is provided downstream of the waste liquid treatment apparatus 100. The pH control tank 122 is provided upstream of the waste liquid treatment tank 104 to thereby increase the efficiency of a catalytic reaction in the waste liquid treatment apparatus 100. Further, the filter 126 is provided upstream of the waste liquid treatment apparatus 100 to thereby remove contaminants such as debris and dust in the waste liquid and prevent the clogging or the like of the catalyst module 102. The filtration level of the filter 126 may be selected from about 1 μm to 300 μm depending upon the target substances to be removed.

The waste liquid treatment apparatus 100 may be provided with a temperature control means capable of controlling the temperature in the waste liquid treatment tank 104 at an appropriate temperature for a catalytic reaction. For example, heating means, cooling means, or the like, of a jacket-type may be provided on an outer periphery of the waste liquid treatment tank 104 for controlling the temperature of the waste liquid. The temperature of the waste liquid is preferably controlled to 15° C. or higher and 60° C. or lower. A temperature of the waste liquid of 15° C. or lower reduces the decomposition rate of hydrogen peroxide. A temperature of the waste liquid exceeding 60° C. requires various measures for heat resistance. The temperature of the waste liquid is more preferably controlled to 30° C. or higher and 50° C. or lower.

As shown in FIG. 19, hydrogen peroxide containing waste liquid, discharged from a semiconductor manufacturing plant 128, is conveyed to the waste liquid treatment apparatus 100 by a pump 132 through an intermediate tank 130. As described above, in the pH control tank 122 the hydrogen peroxide containing waste liquid is adjusted to have an appropriate pH value for a catalytic reaction. Chemicals for the pH control are not particularly limited, but generally used inorganic chemicals such as caustic soda can be used, for example.

The catalyst module 102 and the waste liquid treatment apparatus 100 as described above may be used for the treatment of the waste liquid discharged in a semiconductor substrate or liquid crystal manufacturing process, or for the treatment of the waste liquid discharged in a food manufacturing process or a food fabrication process, for example. Examples of the components in a waste liquid to be decomposed through a catalytic reaction include: hydrogen peroxide; a sulfuric acid/hydrogen peroxide solution (a mixed liquid of sulfuric acid and hydrogen peroxide solution); an ammonia/hydrogen peroxide solution (a mixed liquid of aqueous ammonia and hydrogen peroxide solution); and ozone. In a case where a waste liquid containing hydrogen peroxide is treated, silver is particularly preferably used as a catalyst supported on a catalyst module.

According to the present invention, fibrous activated carbon having a large specific surface area is used. A catalyst module and a treatment apparatus are each constructed to provide a state of efficient contact, thereby attaining high treatment efficiency. Further, the treatment capacity can be easily increased corresponding to increases in the supply rate of the waste liquid. As a result, the treatment capacity can be easily increased at high treatment efficiency. For example, a space velocity (SV) of 50 or more can be easily attained.

During the start up of an operation, no special preliminary processes are required as long as the pH and temperature can be appropriately controlled, and the waste liquid can be supplied at once to start the treatment process.

For example, according to the treatment method of the present invention, in a case where a waste liquid containing about 5,000 ppm of hydrogen peroxide is treated, a decomposition efficiency of 99% or more can be attained.

1. A catalyst module having a waste liquid inlet passage for inflow of a waste liquid, whose partition wall is formed of a fibrous activated carbon, wherein:
the fibrous activated carbon is impregnated with or contains a catalyst; and
the waste liquid in the waste liquid inlet passage passes through the partition wall and is discharged out of the waste liquid inlet passage.

2. A catalyst module according to claim 1, wherein a plurality of the waste liquid inlet passages are arranged in a form of a bundle.

3. A catalyst module according to claim 2, wherein each of the plurality of waste liquid inlet passages are formed between a first partition wall formed to have a wavy section and a second partition wall arranged to follow one side of the first partition wall.

4. A catalyst module according to claim 3, wherein the first partition wall and the second partition wall are arranged concentrically or spirally.

5. A catalyst module according to a claim 1, wherein the fibrous activated carbon is impregnated with or contains silver as a catalyst.

6. A catalyst module according to claim 2, comprising a surface layer surrounding an outer periphery of the plurality of waste liquid inlet passages arranged in the form of a bundle, wherein the surface layer is formed of a material inhibiting passage of a liquid.

7. A catalyst module according to claim 6, wherein the surface layer is formed of a material inhibiting the passage of a liquid and allowing passage of a gas.

8. A catalyst module according to claim 1, wherein the partition wall is formed of a fibrous activated carbon layer prepared by laminating a plurality of the fibrous activated carbon in a form of sheets.

9. A catalyst module according to claim 8, wherein the partition wall comprises a projecting part projecting into the waste liquid inlet passage.

10. A catalyst module according to claim 8, wherein the two or more of the sheet form of the fibrous activated carbon are further formed into a bag comprising an open lower end.

11. A catalyst module according to claim 8, wherein a mesh member is arranged between the sheet forms of the fibrous activated carbon.

12. A catalyst module according to claim 8, wherein:
an inlet port of the waste liquid is provided at a lower end of the waste liquid inlet passage; and
an end of the waste liquid inlet passage opposite to the inlet port is closed to inhibit passage of a liquid.

13. A catalyst module according to claim 8, wherein the fibrous activated carbon is impregnated with or contains silver as a catalyst.

14. A waste liquid treatment apparatus comprising a waste liquid treatment tank capable of holding at least one of the catalyst modules according to claim 1, wherein:
the waste liquid storage tank temporarily stores a treated liquid discharged from the catalyst module; and
the stored treated liquid is discharged out of the waste liquid treatment tank at a predetermined liquid level.

15. A waste liquid treatment apparatus comprising a waste liquid treatment tank capable of holding at least one of the catalyst modules according to claim 5, wherein:
the waste liquid storage tank temporarily stores a treated liquid discharged from the catalyst module; and
the stored treated liquid is discharged out of the waste liquid treatment tank at a predetermined liquid level.

16. A waste liquid treatment apparatus comprising and a waste liquid treatment tank capable of holding at least one of the catalyst modules according to claim 8, wherein:
the waste liquid storage tank temporarily stores a treated liquid discharged from the catalyst module; and
the stored treated liquid is discharged out of the waste liquid treatment tank at a predetermined liquid level.

17. A waste liquid treatment apparatus comprising a waste liquid treatment tank capable of holding at least one of the catalyst modules according to claim 13, wherein:
a the waste liquid storage tank temporarily stores a treated liquid discharged from the catalyst module; and
the stored treated liquid is discharged out of the waste liquid treatment tank at a predetermined liquid level.

18. A waste liquid treatment apparatus according to claim 15, wherein a plurality of the catalyst modules are held in the waste liquid treatment tank in parallel with an inflow direction of the waste liquid.

19. A catalyst module having a waste liquid inlet passage for inflow of a waste liquid, whose partition wall is formed of a fibrous activated carbon, wherein:
the fibrous activated carbon is impregnated with or contains silver as a catalyst;
the partition wall is formed of a fibrous activated carbon layer prepared by laminating a plurality of the fibrous activated carbon in a form of sheets;
the waste liquid inlet surrounds a liquid permeable core member; and
the waste liquid in the waste liquid inlet passage passes through the partition wall and is discharged out of the waste liquid inlet passage.

20. A catalyst module having a waste liquid inlet passage for inflow of a waste liquid, whose partition wall is formed of a fibrous activated carbon, wherein:
the fibrous activated carbon is impregnated with or contains silver as a catalyst;
the fibrous activated carbon is in a form of a sheet;
two or more of the sheet form of the fibrous activated carbon are further formed into a bag open at one end;
a mesh member is located in the bag between the two or more of the sheet form of the fibrous activated carbon; and
the waste liquid in the waste liquid inlet passage passes through the partition wall and is discharged out of the waste liquid inlet passage.
